(19) United States
(12) Patent Application Publication
(10) Pub. No.: US 2026/0331799 A1
(43) Pub. Date: Oct. 22, 2026

(54) ELECTRONIC SYSTEM HAVING PERIMETER CONNECTOR

(71) Applicant: TE Connectivity Solutions GmbH, Schaffhausen (CH)

(72) Inventors: Matthew Ho, Fremont, CA (US); Hamidreza Nahavandi, Fremont, CA (US)

(21) Appl. No.: 19/185,392

(22) Filed: Apr. 22, 2025

(51) Int. Cl. H01R 12/71; H01R 12/70; H01R 12/75; H01R 13/631; H01R 13/66

(52) U.S. Cl. CPC H01R 12/716; H01R 12/7005; H01R 12/75; H01R 13/6315; H01R 13/6658

(57) ABSTRACT

An electronic system includes an electronic package that includes an electronic package substrate configured to be coupled to a host circuit board. The electronic package includes an integrated circuit mounted to the electronic package substrate. The electronic package includes a socket connector mounted to the electronic package substrate and is electrically connected to the integrated circuit. The electronic system includes a perimeter connector separate from the electronic package and configured to be coupled to the host circuit board. The perimeter connector is located proximate to the socket connector outside of a perimeter of the electronic package substrate. The electronic system includes a communication module that includes a first connector interface and a second connector interface. The first connector interface is coupled to the socket connector. The second connector interface is coupled to the perimeter connector.

### BACKGROUND OF THE INVENTION

The subject matter herein relates generally to electronic systems.

Electronic systems are used for data communication. Some electronic systems include an electronic package that is mounted to a host circuit board for data communication. The electronic package includes a communication component, such as an integrated circuit or a computer processor. Data and power are typically transmitted through a package substrate of the electronic package to the communication component. For enhanced data communication, some electronic systems incorporate co-packaged socket connectors that enable separable interfaces between optical modules or copper modules and the electronic package to facilitate high-speed data communication over longer distances. The optical modules and copper modules are powered through the socket connectors. However, such an architecture requires space and contacts at the interfaces for power contacts and low speed data communication, which increases the overall size of the socket connectors and reduces the density of the package for data communication.

A need remains for an electronic system having improved architecture layout to improve data communication and/or reduce overall size and cost of the electronic package.

### BRIEF DESCRIPTION OF THE INVENTION

In one embodiment, an electronic system is provided and includes an electronic package that includes an electronic package substrate configured to be coupled to a host circuit board. The electronic package includes an integrated circuit mounted to the electronic package substrate. The electronic package includes a socket connector mounted to the electronic package substrate and is electrically connected to the integrated circuit. The electronic system includes a perimeter connector separate from the electronic package and configured to be coupled to the host circuit board. The perimeter connector is located proximate to the socket connector outside of a perimeter of the electronic package substrate. The electronic system includes a communication module that includes a first connector interface and a second connector interface. The first connector interface is coupled to the socket connector. The second connector interface is coupled to the perimeter connector.

In another embodiment, an electronic system is provided and includes a host circuit board that includes a first mounting area and a second mounting area at an upper surface of the host circuit board. The first and second mounting areas are separate and spaced apart from each other. The electronic system includes an electronic package coupled to the first mounting area of the host circuit board. The electronic package includes an electronic package substrate coupled to the host circuit board. The electronic package includes an integrated circuit mounted to a top of the electronic package substrate. The electronic package includes a socket connector mounted to the top of the electronic package substrate and is electrically connected to the integrated circuit. The electronic system includes a perimeter connector separate from the electronic package and coupled to the second mounting area of the host circuit board. The perimeter connector is located proximate to the socket connector outside of a perimeter of the electronic package substrate. The electronic system includes a communication module that includes a first connector interface and a second connector interface. The first connector interface is coupled to the socket connector from above. The second connector interface is coupled to the perimeter connector from above.

In a further embodiment, a communication module for data communication with an integrated circuit of an electronic package is provided. The communication module includes a communication module housing that has a mating end and a cable end. The communication module housing extends between a front and a rear. The communication module includes a communication component held by the communication module housing. The communication component is configured to be communicatively coupled to a cable. The communication component includes a first mating area at the mating end and a second mating area at the mating end. The first and second mating areas are separate and spaced apart from each other with the first mating area proximate to the front and the second mating area proximate to the rear. The communication component includes first contacts at the first mating area in a first array configured to be mated to a socket connector of the electronic package. The communication component includes second contacts at the second mating area in a second array configured to be mated to a perimeter connector separate from the electronic package that is located proximate to the socket connector outside of a perimeter of the electronic package. The first contacts include high speed signal contacts configured to transmit high-speed data signals between the communication component and the socket connector and wherein the second contacts include power contacts configured to transmit power and/or low speed signal contacts configured to transmit low speed signals between the communication component and the perimeter connector.

### BRIEF DESCRIPTION OF THE DRAWINGS

FIG. 1 illustrates an electronic system having a co-packaged architecture communicatively coupled with an electronic package in accordance with an exemplary embodiment.

FIG. 2 is a top view of a portion of the electronic system in accordance with an exemplary embodiment.

FIG. 3 is a cross-sectional view of a portion of the electronic system in accordance with an exemplary embodiment.

FIG. 4 is a top view of a portion of the electronic system in accordance with an exemplary embodiment.

FIG. 5 is a cross-sectional view of a portion of the electronic system in accordance with an exemplary embodiment.

FIG. 6 is a cross-sectional view of a portion of the electronic system in accordance with an exemplary embodiment.

FIG. 7 is a perspective view of the communication module in accordance with an exemplary embodiment.

FIG. 8 is a bottom view of the communication module in accordance with an exemplary embodiment.

FIG. 9 is a perspective view of the communication module in accordance with an exemplary embodiment.

FIG. 10 is a bottom view of the communication module in accordance with an exemplary embodiment.

FIG. 11 is a top perspective view of the socket connector in accordance with an exemplary embodiment.

FIG. 12 is a bottom perspective view of the socket connector in accordance with an exemplary embodiment.

FIG. 13 is a top perspective view of the perimeter connector in accordance with an exemplary embodiment.

FIG. 14 is a bottom perspective view of the perimeter connector in accordance with an exemplary embodiment.

### DETAILED DESCRIPTION OF THE INVENTION

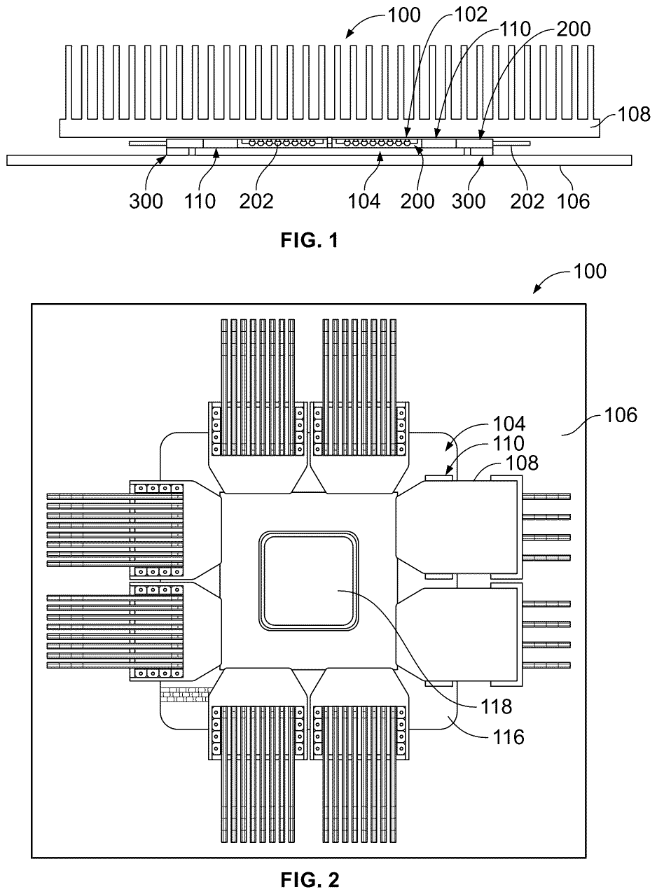

FIG. 1 illustrates an electronic system 100 having a co-packaged architecture 102 communicatively coupled with an electronic package 104. The electronic system 100 includes a host circuit board 106. The electronic package 104 is coupled to the host circuit board 106. For example, the electronic package 104 may be directly mounted to the host circuit board 106. Alternatively, the electronic package 104 may be coupled to the host circuit board 106 by a socket connector (not shown). Data and/or power may be transmitted between the host circuit board 106 and the electronic package 104. In an exemplary embodiment, the electronic system 100 includes a thermal component 108, such as a heat sink or cold plate, for dissipating heat from one of more components of the electronic system 100.

The co-packaged architecture 102 includes communication modules 200 communicatively coupled to the electronic package 104. In an exemplary embodiment, the communication modules 200 are coupled to the electronic package 104 at separable interfaces. For example, the communication modules 200 may be coupled to socket connectors 110 of the electronic package 104. In various embodiments, the communication modules 200 may be co-packaged copper connectors (CPC) including electrical cables having copper signal conductors for transmitting signals. The CPC may include active copper components. The CPC may include passive copper components. In other various embodiments, the communication modules 200 may be co-packaged optic connectors (CPO) including fiber optic cables having optical fibers for transmitting signals.

In an exemplary embodiment, the electronic system 100 includes perimeter connectors 300, separate from the electronic package 104, located outside of the outer perimeter of the electronic package 104. The perimeter connectors 300 may be coupled to the host circuit board 106. For example, the perimeter connectors 300 may be directly mounted to the host circuit board 106. Alternatively, the perimeter connectors 300 may be coupled to the host circuit board 106 through a separable interface, such as a socket connector, receptacle connector, plug connector, or other type of electrical connector. In an exemplary embodiment, the communication modules 200 may be coupled to the corresponding perimeter connectors 300. For example, the communication modules 200 may be coupled to the perimeter connectors 300 at separable interfaces. In an exemplary embodiment, the perimeter connectors 300 may transmit data and/or power between the host circuit board 106 and the communication modules 200. For example, low-speed data signals may be transmitted between the host circuit board 106 and the communication modules 200 via the perimeter connectors 300. High-speed data signals may be transmitted between the communication modules 200 and the electronic package 104 via the socket connectors 110 of the electronic package 104. In an exemplary embodiment, the communication modules 200 are powered via a power interface through the perimeter connectors 300. In an exemplary embodiment, all of the power is supplied to the communication module 200 through the perimeter connector 300 as opposed to through the electronic package 104. As such, the connection interface between the socket connector 110 of the electronic package 104 and the communication modules 200 can be dedicated to high-speed data transmission to increase the high-speed data density and/or reduce the size of the components of the electronic package 104. In various embodiments, some low-speed signals may be transmitted via the socket connectors 110. In various embodiments, some high-speed signals may be transmitted via the perimeter connectors 300. As used herein, “high-speed” data communication is data communication measured in megabits per second (Mbps) or gigabits per second (Gbps), whereas “low-speed” data communication is data communication measured in kilobits per second (Kbps).

In various embodiments, the electronic package 104 is an integrated circuit assembly, such as an ASIC. However, the electronic package 104 may be another type of communication component, such as a processor, an interposer assembly, a socket assembly, a host circuit board assembly, and the like. In an exemplary embodiment, a plurality of communication modules 200 are coupled to the electronic package 104. For example, communication modules 200 may be provided on multiple sides of the electronic package 104, such as on all four sides of the electronic package 104. Other arrangements are possible in alternative embodiments.

In an exemplary embodiment, the thermal device 108 is used to dissipate heat from the electronic package 104, such as from a chip, processor, memory module or other electrical component of the electronic package 104. The thermal device 108 may be used to dissipate heat from the communication modules 200. The thermal device 108 may be used to compress the communication modules 200 against the socket connectors 110 of the electronic package 104 and/or the perimeter connectors 300 to maintain the electrical connection between the communication modules 200 and the socket connectors 110/perimeter connectors 300. The thermal device 108 may be coupled to the host circuit board 106 or a stiffener, such as a bolster plate (not shown), below the host circuit board 106 to compress the thermal device 108. Optionally, features such as threaded posts and/or threaded fasteners may be used to couple the thermal device 108 to the host circuit board 106 and/or the bolster plate. The compression of the thermal device 108 is used for thermal engagement between the thermal device 108 and the communication modules 200 and/or the chip. The compression of the thermal device 108 maintains mechanical and electrical connection between the communication modules 200 and the socket connectors/perimeter connectors 300.

In an exemplary embodiment, a bottom of the electronic package 104 is coupled to the host circuit board 106. In various embodiments, the electronic package 104 may be coupled to the host circuit board 106 at a lower mating interface, such as an LGA interface, a BGA interface, and the like. In an exemplary embodiment, the communication modules 200 are coupled to a top of the electronic package 104 opposite the host circuit board 106, such as to the socket connectors 110 at the top of the electronic package 104. Cables 202 of the communication modules 200 exit the electronic package 104 in a direction from a side of the electronic package 104. In the illustrated embodiment, the cables 202 extend generally horizontally, such as parallel to the host circuit board 106, limiting the height of the electronic system 100. For example, the cables 202 remain located below the thermal device 108. However, in alternative embodiments, the cables 202 may extend vertically through the thermal device 108, such as extending perpendicular to the host circuit board 106. In such embodiment, the cables 202 extend through the thermal device 108 allowing tighter spacing of other components on the host circuit board 106 adjacent the electronic system 100.

The electronic system 100 allows greater density and connections to the electronic package 104 by providing the separate, perimeter connectors 300 located off-package. For example, a subset of the signals (for example, the lower speed signals) and the power may be routed through the perimeter connectors 300, allowing fewer total connections or a greater density of high-speed signals routed through the socket connectors 110 of the electronic package 104. The performance and design efficiency are enhanced by providing the perimeter connectors 300 separate from the electronic package 104 to allow separate connections to the communication modules 200. In an exemplary embodiment, the communication modules 200 are coupled to the electronic package 104 at multiple locations (e.g., at four sides of the chip) to increase density of the electronic system 100. In an exemplary embodiment, the high-speed data signals are transferred directly from the electronic package 104 by the communication modules 200 rather than being first routed through the host circuit board 106 and/or may be routed along longer signal paths through the cables 202 rather than being routed through traces of the host circuit board 106.

FIG. 2 is a top view of a portion of the electronic system 100 in accordance with an exemplary embodiment. The electronic package 104 includes an electronic package substrate 116 and a communication element, such as an integrated circuit 118 provided on the electronic package substrate 116. The integrated circuit 118 may be a chip, processor, memory module or other component mounted to the top of the electronic package 104. In the illustrated embodiment, the integrated circuit 118 is rectangular and approximately centered on the electronic package substrate 116; however, the integrated circuit 118 may have other shapes or locations in alternative embodiments.

The electronic package substrate 116 has conductors (for example, traces, vias, pads, and the like) that provide electrical paths between the integrated circuit 118 and the socket connectors 110 and that provide electrical paths between the integrated circuit 118 and the host circuit board 106. The electronic package substrate 116 may be a printed circuit board. The socket connectors 110 are configured to be coupled to corresponding conductors of the electronic package substrate 116, such as being soldered or press fit to the conductors of the electronic package substrate 116. The socket connectors 110 may be electrically connected to the conductors using contacts, pins, solder balls, conductive elastomeric columns, or other intervening conductive elements.

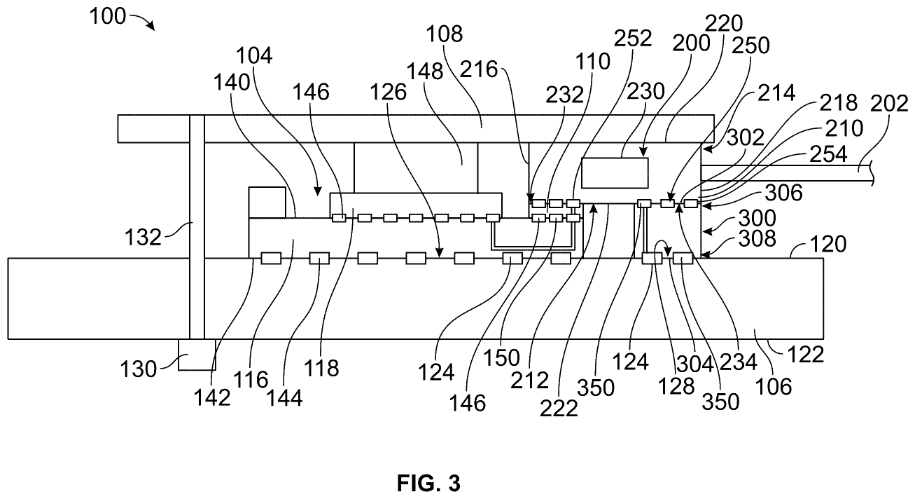

FIG. 3 is a cross-sectional view of a portion of the electronic system 100 in accordance with an exemplary embodiment. FIG. 3 illustrates the host circuit board 106, the electronic package 104 mounted to the host circuit board 106, the perimeter connector 300 mounted to the host circuit board 106, the communication module 200 coupled to the electronic package 104 and the perimeter connector 300, and the thermal device 108 coupled to the electronic package 104 and the communication module 200.

In an exemplary embodiment, the host circuit board 106 includes an upper surface 120 and a lower surface 122. The electronic package 104 is mounted to the upper surface 120. The perimeter connector 300 is mounted to the upper surface 120. Optionally, a plurality of perimeter connectors 300 may be provided, such as at one or more sides and/or surrounding the perimeter of the electronic package 104. The host circuit board 106 includes host board conductors 124 at the upper surface 120. The host board conductors 124 may be solder pads, solder balls, spring beams, or other types of electrical contacts. The host board conductors 124 may include signal conductors, power conductors, ground conductors, or other types of conductors. In an exemplary embodiment, the host circuit board 106 includes a first mounting area 126 and a second mounting area 128 separate from the first mounting area 126. The first mounting area 126 may be spaced apart from the second mounting area 128, such as spaced apart by a gap. The electronic package 104 is coupled to the first mounting area 126 and the corresponding host board conductors 124 at the first mounting area 126. The perimeter connector 300 is coupled to the second mounting area 128 and the corresponding host board conductors 124 at the second mounting area 128.

In an exemplary embodiment, one or more stiffeners 130 are provided at the lower surface 122. The stiffener 130 may be a bolster plate or other type of stiffener. In an exemplary embodiment, a screw 132 or other type of fastener is used to connect components to the host circuit board 106, such as to the stiffener 130. For example, the screw 132 connects the thermal device 108 to the host circuit board 106, such as to create a reliable thermal interface with the component(s) and to apply a compression force to the component(s). The screw 132 may be tightened to compress the thermal device 108 against the components of the electronic system 100, such as the electronic package 104 and/or the communication module 200. In alternative embodiments, the compression may be applied by another compression element rather than being transferred through the thermal device 108, such as compression elements directly connected to the perimeter connector 300 and/or the communication module 200.

In an exemplary embodiment, the electronic package substrate 116 includes an upper surface 140 and a lower surface 142. The integrated circuit 118 is mounted to the upper surface 140. The lower surface 142 is configured to be mounted to the host circuit board 106, such as to the host board conductors 124 arranged in an array for electrical connection with the electronic package substrate 116. The electronic package substrate 116 includes corresponding lower substrate conductors 144 on the lower surface 142 that interface with the host board conductors 124. For example, the lower substrate conductors 144 may be solder pads, solder balls, spring beams, or other types of electrical contacts.

The integrated circuit 118 is provided on the upper surface 140. The integrated circuit 118 may be a chip or other type of integrated circuit. In various embodiments, the integrated circuit 118 may be an ASIC. In an exemplary embodiment, the electronic package substrate 116 includes upper substrate conductors 146 at the upper surface 140. The upper substrate conductors 146 are electrical conductors, such as pads, vias, traces or other circuit components of the electronic package substrate 116. The upper substrate conductors 146 are electrically connected to the integrated circuit 118, such as using a ball grid array (BGA) of solder balls. In an exemplary embodiment, some of the upper substrate conductors 146 are electrically connected to corresponding lower substrate conductors 144 and thus the host circuit board 106, while other upper substrate conductors 146 are electrically connected to corresponding socket connectors 110, such as through circuit traces, vias, and the like of the electronic package substrate 116.

In an exemplary embodiment, a heat transfer device 148 is thermally coupled to the thermal device 108 and the integrated circuit 118 to transfer heat between the integrated circuit 118 and the thermal device 108. The heat transfer device 148 may be a metal block, such as a copper block. The heat transfer device 148 occupies the space between the upper surface of the integrated circuit 118 and the bottom surface of the thermal device 108. The heat transfer device 148 may be a spacer to accommodate the height difference between the integrated circuit 118 and the thermal device 108, such as to accommodate the communication module 200. The thermal device 108 may be compressed against the heat transfer device 148, such as by the screw 132. Alternatively, the thermal device 108 can be separated into multiple parts or elements to create distinct thermal paths for the integrated circuit 118 and the communication module 200.

The socket connector 110 is coupled to the upper surface 140 of the electronic package substrate 116. The socket connector 110 is electrically connected to the integrated circuit 118 via circuits or conductors of the electronic package substrate 116, such as the upper substrate conductors 146. The circuits may be arranged on one or more layers of the electronic package substrate 116. The socket connector 110 includes socket contacts 150 configured to be electrically connected to the upper substrate conductors 146 of the electronic package substrate 116 and are configured to be electrically connected to corresponding communication module contacts 250 of the communication module 200. The socket contacts 150 may include a land grid array (LGA) interface or a ball grid array (BGA) interface for connecting to the electronic package substrate 116 at a separable interface or a fixed/permanent interface. In an exemplary embodiment, the socket contacts 150 may include a LGA interface defining a separable mating interface for mating with the communication module 200.

The perimeter connector 300 is coupled to the upper surface 120 of the host circuit board 106. The perimeter connector 300 is configured to be electrically connected to the communication module 200. The perimeter connector 300 includes an upper interface 302 and a lower interface 304. The upper interface 302 is configured to be electrically connected to the communication module 200. In an exemplary embodiment, the upper interface 302 is a separable interface configured to be separably mated with the communication module 200. For example, the upper interface 302 may be a compression interface. The upper interface 302 may be an LGA interface. In alternative embodiments, the upper interface 302 may be a fixed or permanent interface, such as a solder interface. The lower interface 304 is configured to be electrically connected to the host circuit board 106. In an exemplary embodiment, the lower interface 304 is a fixed or permanent interface. For example, the lower interface 304 may be a BGA interface. The lower interface 304 may be soldered to the host circuit board 106. The perimeter connector 300 includes an upper portion 306 extending from the upper interface 302 and a lower portion 308 extending from the lower interface 304. The lower portion 308 is vertically aligned with the electronic package substrate 116. In various embodiments, the lower interface 304 at the bottom of the lower portion 308 is coplanar with the bottom of the electronic package substrate 116. However, the lower interface 304 and the bottom of the electronic package substrate 116 may be at different levels or elevations in alternative embodiments. In various embodiments, the upper portion 306 is vertically aligned with the socket connector 110. The mating interface of the perimeter connector 300 may be coplanar with the mating interface of the socket connector 110 for mating with the communication module 200. However, the upper interface 302 and the mating interface of the socket connector 110 may be at different levels or elevations in alternative embodiments.

The perimeter connector 300 includes perimeter connector contacts 350 configured to be electrically connected to the host board conductors 124 of the host circuit board 106 at the lower interface 304. The perimeter connector contacts 350 are configured to be electrically connected to corresponding communication module contacts 250 of the communication module 200 at the upper interface 302. The perimeter connector contacts 350 may include pads, balls, spring beams, pogo pins, or other types of contacts. The perimeter connector contacts 350 may form a LGA, a BGA, or other type of interface. In an exemplary embodiment, the perimeter connector 300 is configured to float relative to the electronic package 104 to align mating of the perimeter connector contacts 350 of the perimeter connector 300 with the communication module 200, such as during mating of the communication module 200 with the socket connector 110. The float may be in multiple directions (for example, X and Y directions). In an exemplary embodiment, the perimeter connector 300 is configured to transmit a portion of a mating load of the communication module 200 directly to the host circuit board 106 during mating of the communication module 200 with the perimeter connector 300 and the socket connector 110. As such, the mating forces may be reduced on the socket connector 110 and risk of damage to the socket connector 110 may be reduced.

The communication module 200 is used for data communication with the integrated circuit 118 of the electronic package 104. The communication module 200 includes a communication module housing 210 having a mating end 212 and a cable end 214. The communication module housing 210 extends between a front 216 and a rear 218. The communication module housing 210 includes a top 220 and a bottom 222. The cables 202 extend from the cable end 214. The cables 202 may be electrical cables having copper signal conductors for transmitting signals or fiber optic cables having optical fibers for transmitting signals. In the illustrated embodiment, the cable end 214 is at the rear 218. Other locations are possible in alternative embodiments. In the illustrated embodiment, the mating end 212 is at the bottom 222 for mating with the socket connector 110 and the perimeter connector 300. Other locations are possible in alternative embodiments. The communication module 200 may be mated in a downward mating direction. In an exemplary embodiment, the mating interfaces of the socket connector 110 and the perimeter connector 300 are coplanar for mating with the mating end 212 of the communication module 200.

The communication module 200 includes a communication component 230 held by the communication module housing 210. The communication component 230 is communicatively coupled to the cable 202. The communication component 230 is communicatively coupled to the communication module contacts 250. The communication component 230 may include a printed circuit board or substrate supporting other electrical components. The communication component 230 may include optical components, such as optical transceivers for converting between optical signals and electrical signals. The communication component 230 includes a first mating area 232 at the mating end 212 and a second mating area 234 at the mating end 212. The first and second mating areas 232, 234 are separate and spaced apart from each other. For example, the first mating area 232 may be proximate to the front 216 and the second mating area 234 may be proximate to the rear 218. The communication component 230 includes first communication module contacts 252 at the first mating area 232 in a first array configured for mating with the socket connector 110. The communication component 230 includes second communication module contacts 254 at the second mating area 234 in a second array configured for mating with the perimeter connector 300 separate from the electronic package 104. In an exemplary embodiment, the first communication module contacts 252 are configured to transmit high-speed data signals between the communication component 230 and the socket connector 110 and the second communication module contacts 254 are configured to transmit power and/or low-speed signals between the communication component 230 and the perimeter connector 300.

In an exemplary embodiment, the power circuit for powering the communication module 200 is provided within the perimeter connector 300 separate and remote from the electronic package 104 and is independent of the electronic package substrate 116 and the socket connector 110. Power for the communication module 200 is not transferred across the interface between the socket connector 110 and the electronic package substrate 116 or across the interface between the host circuit board 106 and the electronic package substrate 116, but rather is transferred across the interface between the perimeter connector 300 and the communication module 200. The power interface is off-package. For example, the power interface is outside of the perimeter (not on) the electronic package 104. Having the power transferred through the perimeter connector 300, rather than the socket connector 110, reduces the number of circuits or paths at the interface between the socket connector 110 and the electronic package substrate 116 and at the interface between the host circuit board 106 and the electronic package substrate 116 dedicated to power circuits (which may be zero). Such an arrangement allows a greater number of circuits of the socket connector 110 to be used for high data signal paths or ground paths to enhance the data transfer between the socket connector 110 and the communication module 200 and/or to reduce the footprint of the socket connector 110, and thus the overall electronic package 104, by reducing the number of electrical paths between the socket connector 110 and the communication module 200. For example, in various embodiments, all of the power requirements for the communication module 200 may be handled by the perimeter connector 300 such that there are zero power circuits between the socket connector 110 and the communication module 200.

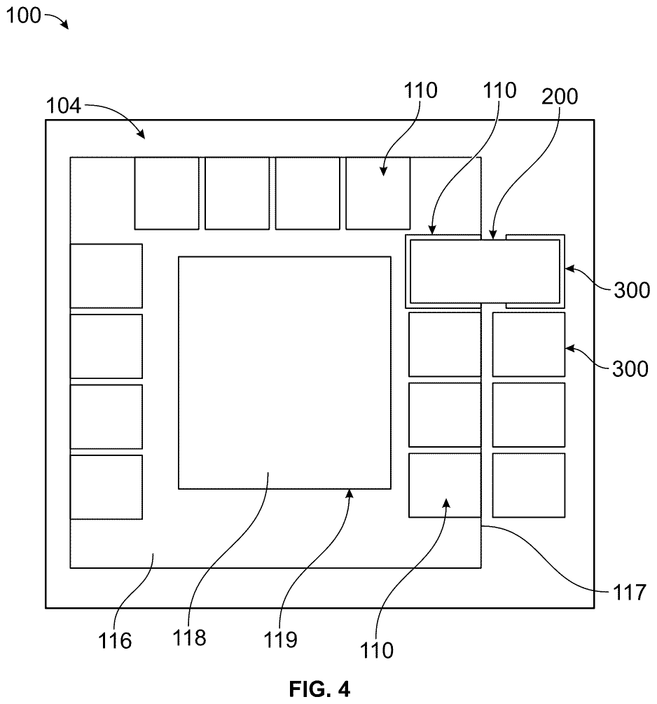

FIG. 4 is a top view of a portion of the electronic system 100 in accordance with an exemplary embodiment. FIG. 4 shows one of the communication modules 200 coupled to the corresponding socket connector 110 and the corresponding perimeter connector 300. A plurality of the perimeter connectors 300 are shown outside of a perimeter of the electronic package substrate 116. The perimeter connectors 300 may be located proximate to, but spaced apart from, the corresponding socket connectors 110 such that both the perimeter connectors 300 and the corresponding socket connectors 110 may be coupled to the same communication module 200.

The perimeter connectors 300 may be arranged along one or more sides 117 of the electronic package substrate 116. In the illustrated embodiment, the perimeter connectors 300 are arranged along one of the sides 117 and the other sides 117 do not have perimeter connectors 300. However, in alternative embodiments, the perimeter connectors 300 are arranged along two sides, three sides or all four sides. The perimeter connectors 300 are positioned beyond the edge at the side 117 and spaced apart from the edge at the side 117. In various embodiments, the perimeter connectors 300 are arranged in a 1:1 ratio with the socket connectors 110. However, in alternative embodiments, a single perimeter connector 300 may be provided associated with multiple socket connectors 110. For example, multiple communication modules 200 may be mated with a single perimeter connector 300.

The integrated circuit 118 is provided on the electronic package substrate 116, such as approximately centered on the electronic package substrate 116 between the sides 117. The socket connectors 110 are provided on one or more sides 119 of the integrated circuit 118. The socket connectors 110 are positioned between the sides 119 of the integrated circuit 118 and the sides 117 of the electronic package substrate 116. The socket connectors 110 may be located at the sides 117 of the electronic package substrate 116. The socket connectors 110 may be located at one side, two sides, three sides, or all four sides of the electronic package substrate 116.

In an exemplary embodiment, the socket connectors 110 transmit high-speed data signals between the communication modules 200 and the electronic package substrate 116. In an exemplary embodiment, the perimeter connectors 300 transmit low-speed data and power between the host circuit board 106 and the communication modules 200. The communication modules 200 are powered via the power interface through the perimeter connectors 300. In an exemplary embodiment, all of the power is supplied to the communication module 200 through the perimeter connector 300 as opposed to through the electronic package 104. As such, the connection interface between the socket connector 110 of the electronic package 104 and the communication modules 200 can be dedicated to the high-speed data transmission to increase the high-speed data density and/or reduce the size of the socket connector 110, and thus the size of the electronic package substrate 116.

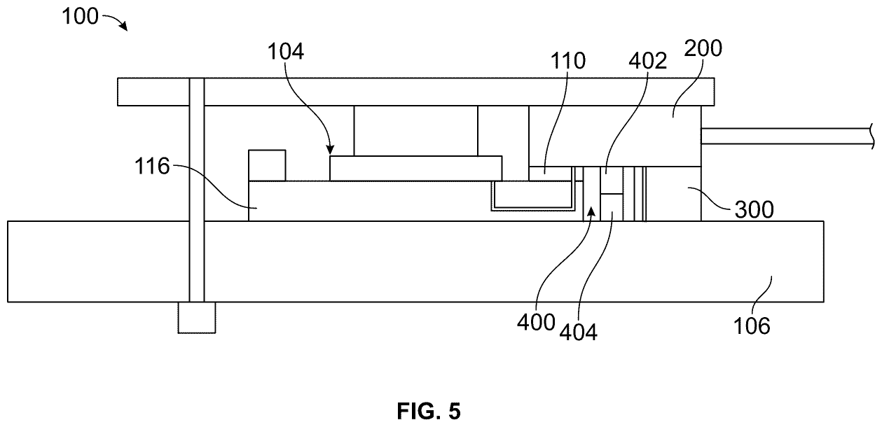

FIG. 5 is a cross-sectional view of a portion of the electronic system 100 in accordance with an exemplary embodiment. FIG. 5 illustrates the host circuit board 106, the electronic package 104 mounted to the host circuit board 106, the perimeter connector 300 mounted to the host circuit board 106, the communication module 200 coupled to the electronic package 104 and the perimeter connector 300, and the thermal device 108 coupled to the electronic package 104 and the communication module 200. FIG. 5 shows an alignment module 400 for aligning the communication module 200 with the socket connector 110 and/or the perimeter connector 300.

The alignment module 400 includes an upper alignment element 402 and a lower alignment element 404. The upper alignment element 402 is coupled to the communication module 200. The lower alignment element 404 is coupled to the host circuit board 106 and/or the perimeter connector 300. The lower alignment element 404 may additionally or alternatively be coupled to the electronic package 104, such as to the electronic package substrate 116 and/or the socket connector 110. The upper alignment element 402 is mated with the lower alignment element 404 to align the communication module 200 with the socket connector 110 and the perimeter connector 300. The upper alignment element 402 may include a post, a pin, a socket, an opening, or other type of alignment element. The lower alignment element 404 may include a socket, an opening, a post, a pin, or other type of alignment element. The alignment elements 402, 404 may allow for lateral and/or longitudinal alignment (for example, X/Y alignment) of the communication module 200 during mating (for example, in the Z direction). The communication module 200 may be configured to float relative to the socket connector 110 and/or the perimeter connector 300 during mating. The socket connector 110 and/or the perimeter connector 300 may allow a predetermined amount of mating tolerance relative to each other to accommodate mating with the communication module 200. In an exemplary embodiment, the perimeter connector 300 may have a larger amount of mating tolerance than the socket connector 110. For example, the socket connector 110 may be designed to have a tighter mating tolerance and the perimeter connector 300 may be designed to have a looser mating tolerance such that the perimeter connector 300 is able to connect to the communication module 200 based on alignment of the communication module 200 with the socket connector 110.

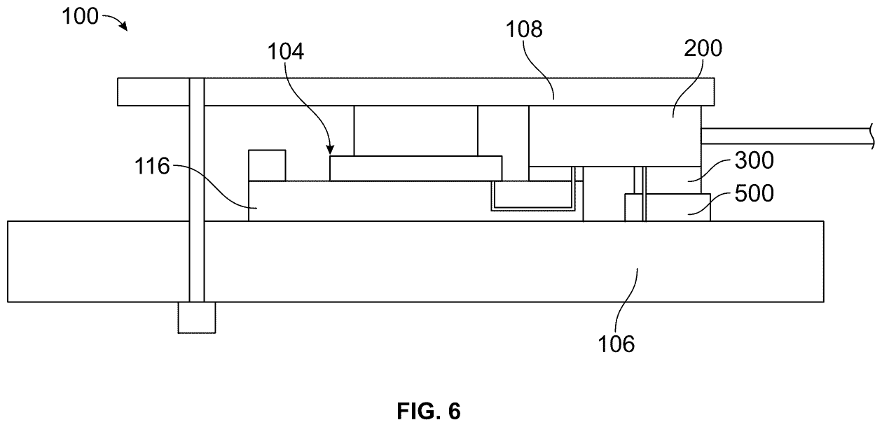

FIG. 6 is a cross-sectional view of a portion of the electronic system 100 in accordance with an exemplary embodiment. FIG. 6 illustrates the host circuit board 106, the electronic package 104 mounted to the host circuit board 106, the perimeter connector 300, the communication module 200 coupled to the electronic package 104 and the perimeter connector 300, and the thermal device 108 coupled to the electronic package 104 and the communication module 200.

In the illustrated embodiment, the electronic system 100 includes a board connector 500 coupled to the host circuit board 106 having a separable mating interface for mating with the perimeter connector 300. The perimeter connector 300 may be coupled to the communication module 200 at a permanent or fixed interface. For example, the perimeter connector 300 may be soldered to the communication module 200 and extend from the bottom of the communication module 200. The board connector 500 is separate from the electronic package 104 and located outside the perimeter of the electronic package substrate 116. The perimeter connector 300 is pluggable with the board connector 500. The board connector 500 may be a plug connector or a receptacle connector. The board connector 500 may be a socket connector. The board connector 500 is configured to transmit low-speed data signals and/or power between the host circuit board 106 and the perimeter connector 300. Such low-speed data signals and/or power is transmitted via the perimeter connector 300 to the communication module 200.

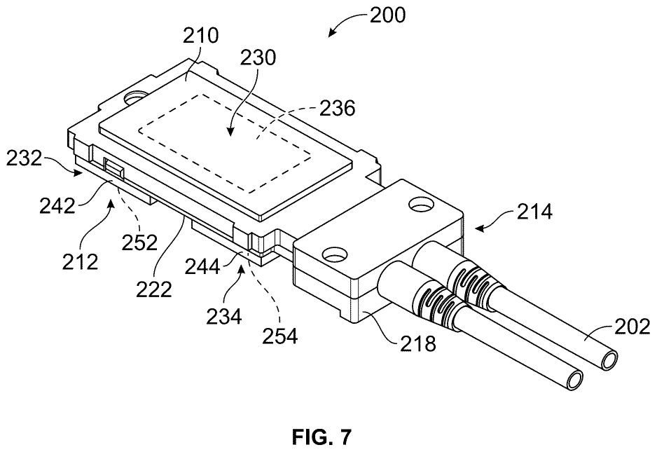

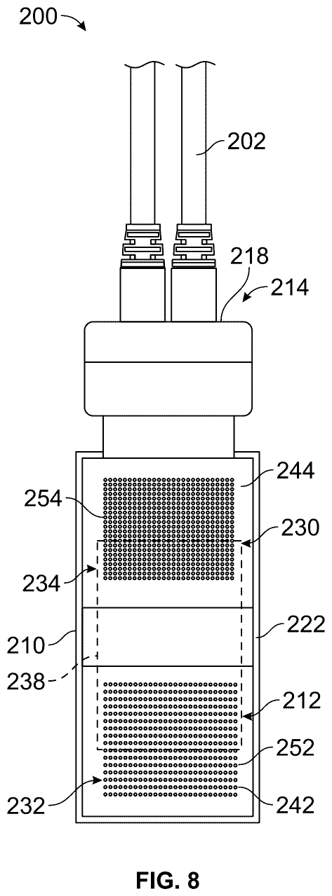

FIG. 7 is a perspective view of the communication module 200 in accordance with an exemplary embodiment. FIG. 8 is a bottom view of the communication module 200 in accordance with an exemplary embodiment. In the illustrated embodiment, the communication module 200 is a co-packaged optic module (CPO). The cables 202 extending from the communication module 200 are fiber optic cables, such as two fiber cables, four fiber cables, ribbon cables, and the like. In an exemplary embodiment, the communication module 200 is an optic module configured to convert between electrical signals and optical signals.

The communication module 200 includes the communication module housing 210 holding the communication component 230. The communication module housing 210 extends between the mating end 212 at the bottom 222 and the cable end 214 at the rear 218. The cables 202 extend from the cable end 214.

In an exemplary embodiment, the communication component 230 includes a first communication module board 242 at the first mating area 232 and a second communication module board 244 at the second mating area 234. The first communication module board 242 holds the corresponding first communication module contacts 252 and the second communication module board 244 holds the corresponding second communication module contacts 254. The contact pitch for the communication module contacts 252 may be the same as, or different from, the contact pitch for the communication module contacts 254. The first communication module board 242 is configured to be mated with the socket connector 110. The second communication module board 244 is configured to be mated with the perimeter connector 300. The communication module boards 242, 244 may be separate boards or may be part of a common board.

In an exemplary embodiment, the communication component 230 includes an optical transceiver 236 configured to convert between electrical signals and optical signals. The optical transceiver 236 may include an optical transmitting device and/or an optical receiving device. The optical transceiver 236 may be connected to the first communication module board 242 and the second communication module board 244. The optical transceiver 236 may receive power through the second communication module contacts 254 and the second communication module board 244 from the perimeter connector 300. The optical transceiver 236 is configured to transmit and/or receive high-speed data signals through the first communication module contacts 252 and the first communication module board 242 with the socket connector 110. In alternative embodiments, the communication component 230 may include a single communication module board rather than the separate first and second communication module boards 242, 244.

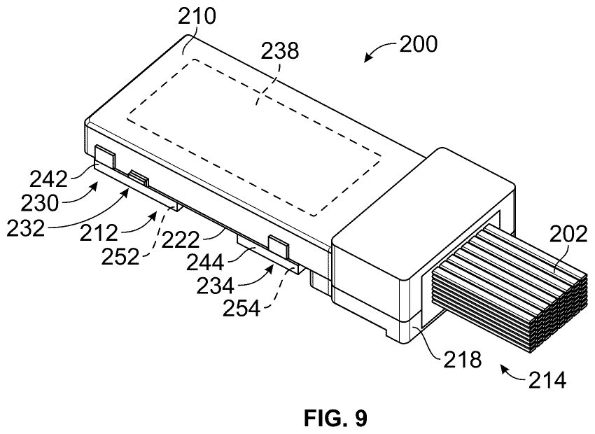

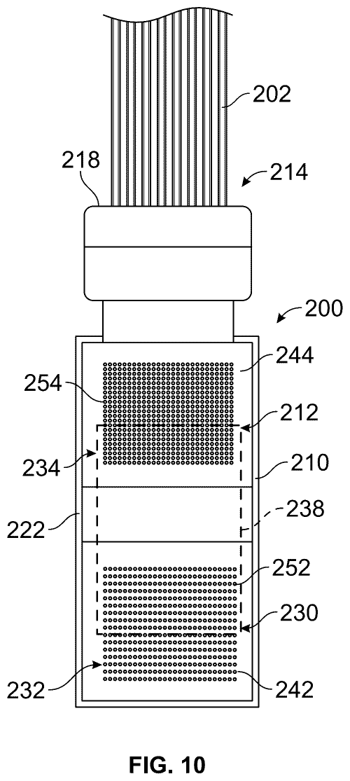

FIG. 9 is a perspective view of the communication module 200 in accordance with an exemplary embodiment. FIG. 10 is a bottom view of the communication module 200 in accordance with an exemplary embodiment. In the illustrated embodiment, the communication module 200 is a co-packaged copper connector (CPC). The cables 202 extending from the communication module 200 are copper conductor cables.

The communication module 200 includes the communication module housing 210 holding the communication component 230. The communication module housing 210 extends between the mating end 212 at the bottom 222 and the cable end 214 at the rear 218. The cables 202 extend from the cable end 214.

In an exemplary embodiment, the communication component 230 includes the first communication module board 242 at the first mating area 232 and the second communication module board 244 at the second mating area 234. The first communication module board 242 holds the corresponding first communication module contacts 252 and the second communication module board 244 holds the corresponding second communication module contacts 254. The first communication module board 242 is configured to be mated with the socket connector 110. The second communication module board 244 is configured to be mated with the perimeter connector 300. In an exemplary embodiment, the communication component 230 includes an active copper component 238, such as a transceiver, gearbox chip, or other active component, configured to boost or extend data signals along the data lines and/or amplify or regenerate the signals along the data lines. The active copper component 238 may be connected to the first communication module board 242 and the second communication module board 244. The active copper component 238 may receive power through the second communication module contacts 254 and the second communication module board 244 from the perimeter connector 300. The active copper component 238 is configured to transmit and/or receive high-speed data signals through the first communication module contacts 252 and the first communication module board 242 with the socket connector 110. In other embodiments, the communication component 230 may be a passive copper component. In alternative embodiments, the communication component 230 may include a single communication module board rather than the separate first and second communication module boards 242, 244.

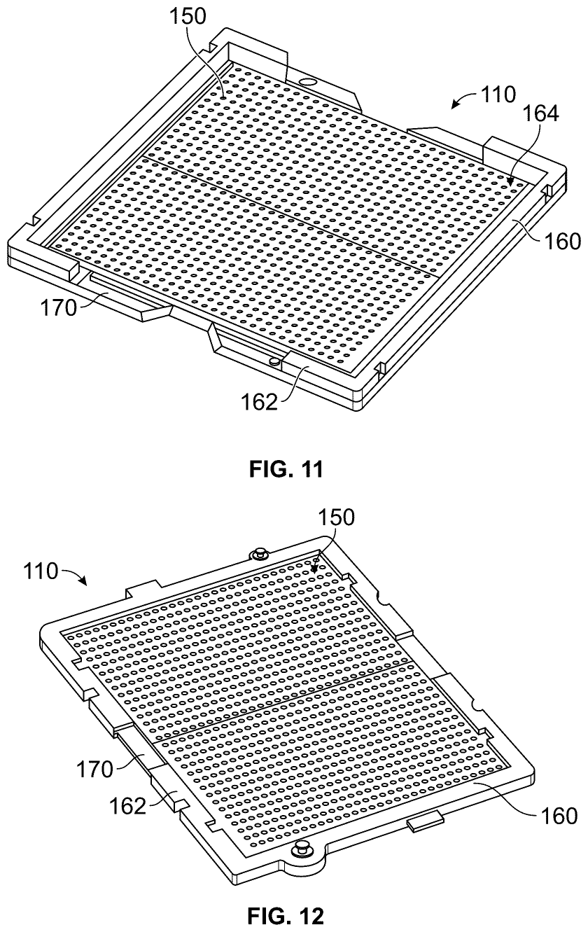

FIG. 11 is a top perspective view of the socket connector 110 in accordance with an exemplary embodiment. FIG. 12 is a bottom perspective view of the socket connector 110 in accordance with an exemplary embodiment. The socket connector 110 includes a socket connector housing 160 and a socket substrate 170 holding the socket contacts 150. The top of the socket connector 110 is configured to be mated with the communication module 200 (shown in FIG. 1). The bottom of the socket connector 110 is configured to be mounted to the electronic package substrate 116 (shown in FIG. 1).

The socket connector housing 160 includes walls 162 forming a cavity or socket 164 configured to receive a portion of the communication module 200. For example, the socket 164 may receive the first communication module board 242 of the communication module 200. In the illustrated embodiment, the socket connector housing 160 is generally rectangular having the walls 162 on four sides of the socket 164. Other shapes are possible in alternative embodiments. The walls 162 are used for alignment or locating of the first communication module board 242 within the socket 164 to align the first communication module contacts 252 with the socket contacts 150. The socket connector housing 160 may hold the socket substrate 170. For example, the walls 162 may be coupled to the socket substrate 170 or the socket substrate 170 may be coupled to the walls 162. The walls 162 may be overmolded around portions of the socket substrate 170. In other various embodiments, the socket substrate 170 may be formed integral with the walls 162. For example, the socket substrate 170 may be a base of the socket connector housing 160.

The socket substrate 170 holds the socket contacts 150 in an array. For example, the socket contacts 150 may be held in columns and rows. The socket contacts 150 may have a uniform pitch in the columns and/or the rows. The socket contacts 150 may be arranged in other patterns in alternative embodiments. The socket contacts 150 may extend through openings or channels in the socket substrate 170 between the top and the bottom of the socket substrate 170 for mating with the communication module 200 and the electronic package substrate 116. The socket contacts 150 may form a LGA or other type of separable interface at the upper mating interface. For example, the socket contacts 150 may include spring beams at the upper mating interface. The socket contacts 150 may form a LGA or a BGA or other type of interface at the lower mating interface. For example, the socket contacts 150 may include solder pads, solder balls, spring beams, or other types of contacts at the lower mating interface.

In an exemplary embodiment, the socket contacts 150 may include signal contacts arranged in pairs, wherein each pair is configured to convey a differential high-speed data signals. The pairs of the signal contacts of the socket contacts 150 may be surrounded by ground contacts to provide shielding around the pair of the signal contacts. Other arrangements are possible in alternative embodiments. In various embodiments, the socket contacts 150 include only high-speed data signal contacts and ground contacts and do not include any low-speed data signal contacts or power contacts. Rather, the low-speed data signals and power are transmitted to the communication module 200 via the perimeter connector 300 remote from the socket connector 110. In other various embodiments, some of the socket contacts 150 may be used for low-speed data signaling and/or power transmission; however, a subset of the signaling and/or power may be transmitted to the communication module 200 via the perimeter connector 300 remote from the socket connector 110.

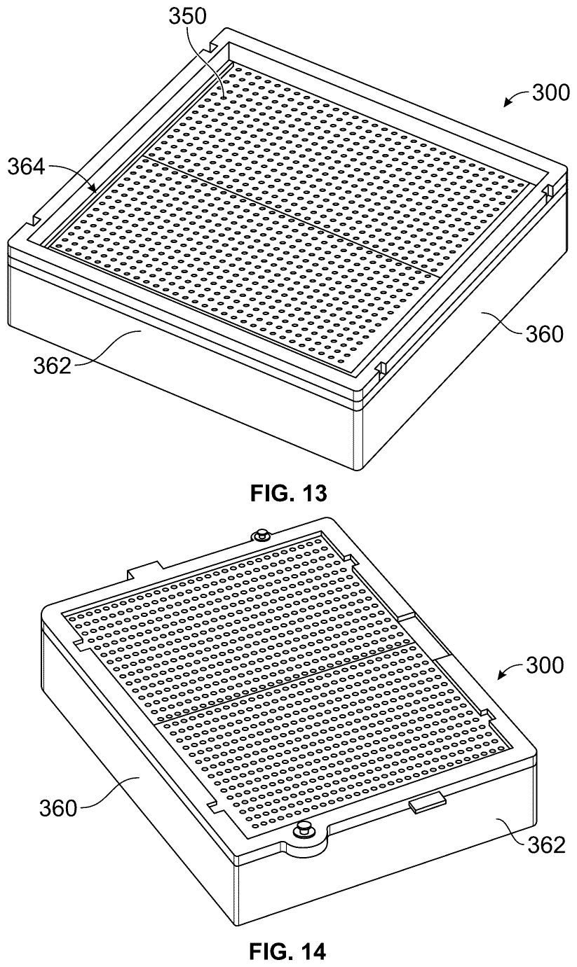

FIG. 13 is a top perspective view of the perimeter connector 300 in accordance with an exemplary embodiment. FIG. 14 is a bottom perspective view of the perimeter connector 300 in accordance with an exemplary embodiment. The perimeter connector 300 includes a perimeter connector housing 360 holding the perimeter contacts 350. The top of the perimeter connector 300 is configured to be mated with the communication module 200 (shown in FIG. 1). The bottom of the perimeter connector 300 is configured to be mounted to the host circuit board 106 (shown in FIG. 1).

The perimeter connector housing 360 includes walls 362 forming a socket 364 configured to receive a portion of the communication module 200. For example, the socket 364 may receive the second communication module board 244 of the communication module 200. In the illustrated embodiment, the perimeter connector housing 360 is generally rectangular having the walls 362 on four sides of the socket 364. Other shapes are possible in alternative embodiments. The walls 362 are used for alignment or locating of the second communication module board 244 within the socket 364 to align the second communication module contacts 254 with the perimeter contacts 350. In other various embodiments, the perimeter connector housing 360 may be provided without the socket 364, rather having a flat top.

The perimeter connector housing 360 holds the perimeter contacts 350 in an array. For example, the perimeter contacts 350 may be held in columns and rows. The perimeter contacts 350 may have a uniform pitch in the columns and/or the rows. The perimeter contacts 350 may be arranged in other patterns in alternative embodiments. The perimeter contacts 350 may extend through openings or channels in the perimeter connector housing 360 between the top and the bottom of the perimeter connector housing 360 for mating with the communication module 200 and the host circuit board 106. The perimeter contacts 350 may form an LGA or other type of separable interface at the upper mating interface. For example, the perimeter contacts 350 may include spring beams at the upper mating interface. The perimeter contacts 350 may form a LGA or a BGA or other type of interface at the lower mating interface. For example, the perimeter contacts 350 may include solder pads, solder balls, spring beams, or other types of contacts at the lower mating interface. In an exemplary embodiment, the perimeter contacts 350 may include low-speed signal contacts, ground contacts, power contacts or other types of contacts.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electronic system comprising:
an electronic package including an electronic package substrate configured to be coupled to a host circuit board, the electronic package including an integrated circuit mounted to the electronic package substrate, the electronic package including a socket connector mounted to the electronic package substrate and being electrically connected to the integrated circuit;
a perimeter connector separate from the electronic package and configured to be coupled to the host circuit board, the perimeter connector located proximate to the socket connector outside of a perimeter of the electronic package substrate; and
a communication module including a first connector interface and a second connector interface, the first connector interface coupled to the socket connector, the second connector interface coupled to the perimeter connector.

2. The electronic system of claim 1, wherein the electronic package substrate includes a first side edge defining a portion of the perimeter of the electronic package substrate, the socket connector mounted to the electronic package substrate between the first side edge and the integrated circuit, the perimeter connector positioned beyond the first side edge and being spaced apart from the first side edge.

3. The electronic system of claim 1, wherein the perimeter connector includes an upper portion and a lower portion, the lower portion being vertically aligned with the electronic package substrate, the upper portion being vertically aligned with the socket connector.

4. The electronic system of claim 1, wherein the perimeter connector includes a lower interface configured to be coupled to the host circuit board and an upper interface configured to be coupled to the second connector interface of the communication module, the lower interface being coplanar with a bottom of the electronic package substrate, the upper interface being coplanar with a top of the socket connector.

5. The electronic system of claim 1, wherein the socket connector includes high-speed data contacts transmitting high-speed data signals between the electronic package substrate and the communication module, the perimeter connector including power contacts configured to transmit power between the host circuit board and the communication module.

6. The electronic system of claim 5, wherein the perimeter connector includes low-speed data contacts transmitting low-speed data signals between the host circuit board and the communication module.

7. The electronic system of claim 1, wherein power transmission to the communication module flows primarily through the perimeter connector.

8. The electronic system of claim 1, wherein the perimeter connector is configured to float relative to the electronic package to align mating of the perimeter connector with the communication module during mating with the socket connector.

9. The electronic system of claim 1, further comprising an alignment module configured to align the communication module to at least one of the socket connector and the perimeter connector.

10. The electronic system of claim 1, wherein the socket connector includes a compressible interface at a top of the socket connector for mating with the first connector interface, the perimeter connector including a compressible interface at a top of the perimeter connector for mating with the second connector interface.

11. The electronic system of claim 1, wherein the perimeter connector is configured to transmit a portion of a mating load of the communication module directly to the host circuit board during mating of the communication module with the perimeter connector and the socket connector.

12. The electronic system of claim 1, wherein the communication module comprises:
a communication module housing having a mating end and a cable end, the communication module housing extending between a front and a rear;
a cable extending from the cable end;
a communication component held by the communication module housing, the communication component being communicatively coupled to the cable, the communication component including a first mating area defining the first mating interface and a second mating area defining the second mating interface, the first and second mating areas being separate and spaced apart from each other with the first mating area proximate to the front and the second mating area proximate to the rear, the communication component including first contacts at the first mating area in a first array configured for mating with the socket connector of the electronic package, the communication component including second contacts at the second mating area in a second array configured for mating with the perimeter connector;
wherein the first contacts are configured to transmit high-speed data signals between the communication component and the socket connector and wherein the second contacts are configured to transmit power between the communication component and the perimeter connector.

13. The electronic system of claim 1, wherein the communication module is an optic module configured to convert between electrical signals and optical signals, the optic module including an optical transmitting device in an optical receiving device.

14. An electronic system comprising:
a host circuit board including a first mounting area and a second mounting area at a surface of the host circuit board, the first and second mounting areas being separate and spaced apart from each other;
an electronic package coupled to the first mounting area of the host circuit board, the electronic package including an electronic package substrate coupled to the host circuit board, the electronic package including an integrated circuit mounted to the electronic package substrate, the electronic package including a socket connector mounted to the electronic package substrate and being electrically connected to the integrated circuit;
a perimeter connector separate from the electronic package and coupled to the second mounting area of the host circuit board, the perimeter connector located proximate to the socket connector outside of a perimeter of the electronic package substrate; and
a communication module including a first connector interface and a second connector interface, the first connector interface coupled to the socket connector in a mating direction, the second connector interface coupled to the perimeter connector in the mating direction.

15. The electronic system of claim 14, further comprising a thermal device thermally coupled to the integrated circuit and the communication module.

16. The electronic system of claim 14, wherein the perimeter connector includes a lower interface coupled to the surface of the host circuit board at the second mounting area and an upper interface configured to be coupled to the second connector interface of the communication module, the lower interface being coplanar with a bottom of the electronic package substrate, the upper interface being coplanar with a top of the socket connector.

17. The electronic system of claim 14, wherein the socket connector includes high-speed data contacts transmitting high-speed data signals between the electronic package substrate and the communication module, the perimeter connector including power contacts configured to transmit power between the host circuit board and the communication module.

18. The electronic system of claim 14, wherein the communication module comprises:
a communication module housing having a mating end and a cable end, the communication module housing extending between a front and a rear;
a cable extending from the cable end;
a communication component held by the communication module housing, the communication component being communicatively coupled to the cable, the communication component including a first mating area defining the first mating interface and a second mating area defining the second mating interface, the first and second mating areas being separate and spaced apart from each other with the first mating area proximate to the front and the second mating area proximate to the rear, the communication component including first contacts at the first mating area in a first array configured for mating with the socket connector of the electronic package, the communication component including second contacts at the second mating area in a second array configured for mating with the perimeter connector;
wherein the first contacts are configured to transmit high-speed data signals between the communication component and the socket connector and wherein the second contacts are configured to transmit power between the communication component and the perimeter connector.

19. A communication module for data communication with an integrated circuit of an electronic package, the communication module comprising:
a communication module housing having a mating end and a cable end, the communication module housing extending between a front and a rear; and
a communication component held by the communication module housing, the communication component configured to be communicatively coupled to a cable, the communication component including a first mating area at the mating end and a second mating area at the mating end, the first and second mating areas being separate and spaced apart from each other with the first mating area proximate to the front and the second mating area proximate to the rear, the communication component including first contacts at the first mating area in a first array configured to be mated to a socket connector of the electronic package, the communication component including second contacts at the second mating area in a second array configured to be mated to a perimeter connector separate from the electronic package that is located proximate to the socket connector outside of a perimeter of the electronic package;
wherein the first contacts include high speed signal contacts configured to transmit high-speed data signals between the communication component and the socket connector and wherein the second contacts include power contacts configured to transmit power between the communication component and the perimeter connector.

20. The communication module of claim 19, wherein the communication component includes third contacts at the second mating area configured for mating with the perimeter connector, the third contacts are configured to transmit low-speed data signals between the communication component and the perimeter connector.
